(19) United States
(12) Patent Application Publication
(10) Pub. No.: US 2016/0042376 A1
(43) Pub. Date: Feb. 11, 2016

(54) USED MOTOR VEHICLE PRICING SYSTEM

(71) Applicant: CARPROOF, London (CA)

(72) Inventors: Joe Luther, Novi, MI (US); Bill Luther, Rochester Hills, MI (US); Paul Anthony, London (CA); Holden Rhodes, London (CA)

(21) Appl. No.: 14/773,726

(22) PCT Filed: Mar. 11, 2014
(86) PCT No.: PCT/IB2014/001610

§ 371 Date: Sep. 8, 2015

Related U.S. Application Data
(60) Provisional application No. 61/776,116, filed on Mar. 11, 2013.

(51) Int. Cl. G06Q 30/02

(52) U.S. Cl. CPC G06Q 30/0206

(57) ABSTRACT

A method and system of presenting used motor vehicle pricing information to a data user. In addition to previously available information, new data are gathered including historical data regarding the asking price and sale price of the specific vehicle and similar vehicles. By obtaining and presenting used-car pricing and actual sold pricing information for similar vehicles along with the specific historical data elements for a specific used vehicle, modified in accordance with certain algorithms and methodologies, valuable pricing information can be made available to vehicle purchasers lending institutions, insurance companies, and others involved in transactions related to used vehicles.

### FIELD OF THE INVENTION

This invention relates to a method for obtaining and presenting data useful in transactions involving used motor vehicles.

### BACKGROUND OF THE INVENTION

There are numerous commercial transactions involved with respect to used motor vehicles. For example private commercial purchasers of used motor vehicles desire complete information regarding a particular motor vehicle as well as other vehicles of the same model, type, and year (similar vehicles) which will inform the purchaser regarding the desirability of the vehicle, as well provide some guidance regarding an appropriate price. Lending agencies which lend funds for purchase or finance inventories of vehicles similarly require information related to the value of the particular motor vehicle. Motor vehicle insurers also require useful data regarding vehicle valuation as part of rating vehicles for insurance coverage and in connection with handling loss claims. Law enforcement agencies also make use of vehicle data reports in various situations related to criminal investigations and other activities. Organizations receiving donated vehicles also desire information concerning the vehicle as it is related to the value of a donation, for tax or other purposes.

There are numerous service providers which currently provide reports and data to interested parties involving used (and new) motor vehicles. Such service providers provide sets of data regarding vehicles which may include the following:
1. Vehicle recall history which includes information of any governmental agency required recall as well as industry initiated actions to correct vehicle defects.
2. Accident data which includes records of any accident claims affecting a particular vehicle. This information may include specific information concerning an accident claim costs, deductibility information, and information regarding denial of claim.
3. Casualty records including information regarding flood, fire, or other environmental damage to a vehicle, and if the vehicle was involved in criminal activities such as recorded as stolen or vandalized etc.
4. Repair and maintenance data including records of dealership and maintenance repair shop activity concerning a particular vehicle.
5. Registration records which may include a history of recorded ownership of the vehicle, and registrations in any jurisdiction (including country state province etc.). This information will also capture vehicle title record items such as salvage, rebuild, non-repair of all or other status indicators, as well as import records.
6. A detailed chronology of the vehicle including the date the vehicle was first put into service.
7. Lien data including records of recorded security interest of financial institutions for a particular vehicle.
8. Third party history including information about antitheft systems installed, independent inspections and other inspections/maintenance records (dealership, oil change shop, maintenance shop, etc.) supplied by data sources.
9. Miscellaneous other inspection data from sources such as auto auctions, third-party inspection services, and government or environmental inspection agencies.

The previously noted information is currently available from a variety of service providing companies. These companies differ in the manner in which they present their reports and the means of access to the information i.e. web-based database access, etc. Presently available motor vehicle information has proven very beneficial and valuable to those concerned with vehicle financial transactions. Despite the depth of information presently available, there remains an area where complete data are missing; namely, certain data related to vehicle pricing, and in particular, private transaction-used vehicle pricing. An innovation of this invention is to use this new data and other more traditional history data on a “vehicle specific basis” to provide a unique vehicle valuation report for a specific vehicle.

### BRIEF DESCRIPTION OF THE DRAWING

FIG. 1 is a graphical representation of a general computer system which may be configured to carry out the present invention.

### DESCRIPTION OF THE INVENTION

In accordance with the present invention, a method and system of presenting used motor vehicle pricing information to a data user is described. In addition to previously available information, new data are gathered including historical data regarding the asking price and sale price of the particular vehicle and of similar vehicles. Used vehicle pricing information is potentially available from a variety of sources. For example, these data could include information from the original manufacturer (original suggested retail and dealer price), and subsequent retail reselling service agencies such as Auto trader, cars.com eBay Motors, etc. Asking prices for used vehicles are presented in various publicly available resources such as Internet-based classified advertising such as Craigslist, newspaper classified advertising (becoming antiquated), specialty used vehicle publications and databases such as AutoTrader (and autotrader.com), and commercial used vehicle selling organizations such as car dealerships, used-car lots etc. In addition, various sources of data exist which can provide the actual sold prices of particular used vehicles. By obtaining and presenting used-car pricing and actual sold pricing information for similar vehicles along with the specific historical data elements for a particular used vehicle, modified in accordance with certain algorithms and methodologies, valuable pricing information can be made available to vehicle purchasers lending institutions, insurance companies, and others involved in transactions related to used vehicles.

In accordance with the present invention, a methodology and system for presenting used vehicle price information is provided. It is intended that this methodology and system will be used in conjunction with existing motor vehicle data mining and reporting methodologies including those discussed previously. In that regard, data including those related to the enumerated data areas, numbered 1 through 9 presented above are gathered and reported. The new data derived from sources including those mentioned previously are collected for a particular motor vehicle. These data are recorded and processed in a manner which makes them useful for subsequent consideration for financial transactions. In this regard, existing composite data for a particular vehicle CVDₐ is collected. These data for a particular vehicle include a collection of data relevant to pricing related to similar vehicles will which are recorded and later processed. Potentially included in these data are:
Pₐ—Price for Vehicle a basic price;
MYₐ—Model year of Vehicle a;
PTₐ—Price type, asked for price, sales price, private sale price, dealership price, auction price for Vehicle a and similar vehicles;
NPₐ—Price for Vehicle a as new based on manufacturer's suggested retail price (MSRP);
BSₐ—Body style of Vehicle a, eg. coupe, sedan, convertible;
TPₐ—Trim package for Vehicle a;
Mₐ—Mileage of Vehicle a;
Oₐ—Option value for Vehicle a (sunroof, trim package, wheels, tires, interior (e.g. leather, cloth);
Eₐ—Engine option for Vehicle a eg. V8, V6, 4cyl, torbo, diesel;
Cₐ—Vehicle a condition (clean, fair);
Tₐ—Transmission of Vehicle a, e.g. automatic, manual shift;
Rₐ—Geographic sale region, e.g. West Coast, East Coast, Midwest, South, Canada, etc.;
Aₐ—Accident damage reported by various agencies for Vehicle a
Hₐ—Historical data reported by various agencies for Vehicle a;
BBPₐ—Blue Book pricing data; and
Mₐ—Miscellaneous factors affecting price.

These data for a particular vehicle (Vehicle a) or similar vehicles are collected in a matrix or as a composite dataset:

CVDa{Pₐ,MYₐ,PTₐ,NPₐ,BSₐ,TPₐ,Mₐ,Oₐ,Eₐ,Cₐ,Tₐ,Rₐ,BBPₐ,MₐAₐHₐ}

These data for numerous similar vehicles are collected (CVDₙ) and stored in a matrix form. Since it is expected that no two vehicles will be identical data sets, when a particular vehicle (Vehicle a) is to be compared against existing data for similar vehicles, a projected vehicle price (PVPₙ) is calculated by collecting data related to the above matrix and applying weighting factors (WF) for those data:

PVPₙ˜WF₁Pₐ,WF₂MYₐ,WF₃PTₐ,WF₄NPₐ,WF₅BSₐ,WF₆TPₐ,WF₇Mₐ,WF₈Oₐ,WF₉Eₐ,WF₁₀Cₐ, WF₁₁,Tₐ,WF₁₂Rₐ,WF₁₃BBPₐ,WF₁₄MₐWF₁₅AₐWF₁₆Hₐ

The values of weighting factors WF₁₋₁₄ can be determined using various techniques. For example, statistical regression analysis can be conducted to develop correlations among data points from which statistically verifiable relationships may be established. Computer generated curve fitting algorithms may also be employed. It is anticipated that the weighting functions will be continually refined as more data becomes available and as new model years vehicles become available.

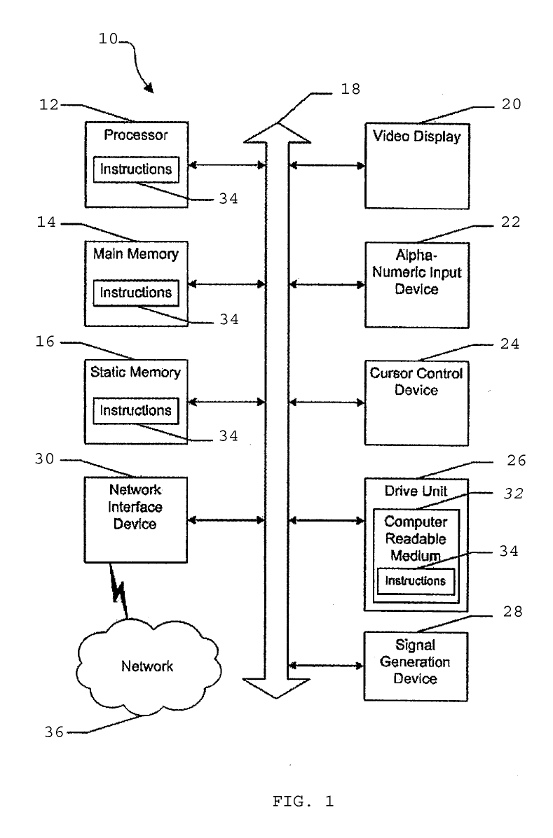

Referring to FIG. 1, an illustrative embodiment of a general computer system is shown and is designated 10. The computer system 10 may be the system of presenting used motor vehicle pricing information to a data user described in the paragraphs above. The computer system 10 can include a set of instructions 34 that can be executed to cause the computer system 10 to perform any one or more of the methods or computer based functions disclosed herein. The computer system 10 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 10 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 90 can be implemented using electronic devices that provide voice, video or data communication. Further, while a single computer system 10 is illustrated, the term “system” shall also be taken to include any collection of systems or sub-systems that individually or jointly execute a set, or multiple sets, of instructions to perform one or more computer functions.

As illustrated in FIG. 1, the computer system 10 may include a processor 12, e.g., a central processing unit (CPU), a graphics processing unit (GPU), or both. Moreover, the computer system 10 can include a main memory 14 and a static memory 16 that can communicate with each other via a bus 18. As shown, the computer system 10 may further include a video display unit 20, such as a liquid crystal display (LCD), an organic light emitting diode (OLED), a flat panel display, a solid state display, or a cathode ray tube (CRT). Additionally, the computer system 10 may include an input device 22, such as a keyboard, and a cursor control device 24, such as a mouse. The computer system 10 can also include a disk drive unit 26, a signal generation device 28, such as a speaker or remote control, and a network interface device 30.

In a particular embodiment, as depicted in FIG. 1, the disk drive unit 26 may include a computer-readable medium 32 in which one or more sets of instructions 34, e.g. software, can be embedded. Further, the instructions 34 may embody one or more of the methods or logic as described herein. In a particular embodiment, the instructions 34 may reside completely, or at least partially, within the main memory 14, the static memory 16, and/or within the processor 12 during execution by the computer system 10. The main memory 14 and the processor 12 also may include computer-readable media.

In an alternative embodiment, dedicated hardware implementations, such as application specific integrated circuits (ASIC), programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules,

or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 34 or receives and executes instructions 34 responsive to a propagated signal, so that a device connected to a network 36 can communicate voice, video or data over the network 36. Further, the instructions 34 may be transmitted or received over the network 36 via the network interface device 30.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory (RAM) or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

While the above description constitutes the preferred embodiment of the present invention, it will be appreciated that the invention is susceptible to modification, variation and change without departing from the proper scope and fair meaning of the accompanying claims.

1. A method of providing a projected motor vehicle price (PVPₙ) for use in financial transactions involving a particular used motor vehicle including the steps of:
collecting data related to pricing of used motor vehicles similar the particular used vehicle,
collecting additional historical price data for the particular vehicle including one or more of, an asked for price, a sales price, a private sale price, a dealership price, and an auction price, and
estimating the value of the particular used motor vehicle by evaluating those collected data related to pricing and those collected additional historical price data and applying weighting factors to those data to calculate the projected vehicle pricing value (PVPₙ).

2. The method of providing projected motor vehicle price in accordance with claim 1 further comprising wherein the data related to pricing or the additional historical price data includes one or more of:
price for the particular vehicle (Pₐ),
model year of the similar vehicle (MYₐ),
price type (PTₐ) for the additional historical price data,
new price for the similar vehicle (NPₐ),
body style of the similar vehicle (BSₐ),
trim package for the similar vehicle (TPₐ),
mileage of the similar vehicle (Mₐ),
option value for the similar vehicle (Oₐ),
engine option for the similar vehicle (Eₐ),
vehicle condition of the similar vehicle (Cₐ),
transmission of the similar vehicle (Tₐ),
geographic sale region for the similar vehicle (Rₐ),
accident damage reported for the particular vehicle (Aₐ),
historical data reported for the particular vehicle (Hₐ),
historical pricing data for the similar vehicles, and
miscellaneous factors affecting price for the particular vehicle (Mₐ).

3. The method of providing projected motor vehicle price in accordance with claim 1 wherein the data related to pricing and the additional historical price data comprises:
price for the particular vehicle (Pₐ),
model year of the similar vehicle (MYₐ),
price type (PTₐ) for the additional historical price data,
new price for the similar vehicle (NPₐ),
body style of the similar vehicle (BSₐ),
trim package for the similar vehicle (TPₐ),
mileage of the similar vehicle (Mₐ),
option value for the similar vehicle (Oₐ),
engine option for the similar vehicle (Eₐ),
vehicle condition of the similar vehicle (Cₐ),
transmission of the similar vehicle (Tₐ),
geographic sale region for the similar vehicle (Rₐ),
accident damage reported for the particular vehicle (Aₐ),
historical data reported for the particular vehicle (Hₐ),
historical pricing data for the similar vehicles, and
miscellaneous factors affecting price for the particular vehicle (Mₐ).

4. The method of providing projected motor vehicle price in accordance with claim 1 wherein the step of collecting additional historical price data comprises obtaining the price data from records of past transactions involving the particular vehicle.

5. The method of providing projected motor vehicle price in accordance with claim 1 further comprising the step of collecting and reporting one or more of the following additional data:
a vehicle recall history for the particular vehicle,
accident data for the particular vehicle,
casualty records for the particular vehicle,
repair and maintenance data for the particular vehicle,
registration records for the particular vehicle,
chronology information for the particular vehicle,
lean data for the particular vehicle, and
third-party history data for the particular vehicle.

6. A general-purpose computer configured to carry out the method of claim 1.
